(19) United States
(12) Patent Application Publication
(10) Pub. No.: US 2019/0366265 A1
(43) Pub. Date: Dec. 5, 2019

(54) SPILL RESISTANT AND MOISTURE ABSORBING DEVICE

(71) Applicant: W.M. Barr & Company, Inc., Memphis, TN (US)

(72) Inventors: Donald Aaron Lankford, Collierville, TN (US); Matthew Michael Petkus, Memphis, TN (US); Wendy Groover, Germantown, TN (US); Brett Justin Healey, Memphis, TN (US); Shannon Wheeler, Arnold, MD (US); Douglas Pemberton, Lutherville-Timonium, MD (US); Barry Wood, Memphis, TN (US); Rachel Farmer, Memphis, TN (US)

(21) Appl. No.: 16/426,401

(22) Filed: May 30, 2019

Related U.S. Application Data
(60) Provisional application No. 62/679,217, filed on Jun. 1, 2018.

(51) Int. Cl. B01D 53/26; B01D 53/04

(52) U.S. Cl. CPC B01D 53/261; B01D 53/0407; B01D 2259/4525; B01D 2259/4508; B01D 2257/80

(57) ABSTRACT

A spill-resistant and moisture absorbing device comprises a lid, a cover having a wall with an opening and attachably connected to the lid, a tray having an upper side and an underside and attachably connected to the cover from an upper side of the tray, and a basin having a cavity for collection of brine and attachably connected from the underside of the tray. The tray comprises a holder for holding a tablet.

### CROSS-REFERENCE TO RELATED APPLICATIONS

This application claims priority from. U.S. Provisional Patent Application No. 62/679,217, filed on Jun. 1, 2018, in the United States Patent and Trademark Office. The disclosure of which is incorporated herein by reference in its entirety.

### HELD OF THE INVENTION

The present invention relates to a spill resistant and moisture absorbing device, more particularly to a spill resistant and moisture absorbing device having a compressed tablet.

### BACKGROUND OF THE INVENTION

Atmospheric water vapor in high humidity environments can be problematic to personal articles, clothing for example, and other items which are susceptible to corrosion, mold, mildew, and other types of water related damage and deterioration. Also, the interior of vehicles, boats and airplanes that are subjected to wet and humid weather conditions can develop odors as well as mildew and mold, and can rot from constant exposure to humid air. Homes with poor sealing, especially in rainy climates are especially vulnerable to damage cause by humidity. For these reasons the consumer desire dehumidifying products that will act quickly to remove moisture fast when they are experiencing immediate moisture threats from large storms and flooding, and products that will last a long time when they are trying to maintain a healthy humidity level for storage of items. Since people also use these dehumidifying devices to treat already flooded areas, which might have mildew odors, they are also looking for products that work to remove malodor and moisture.

There are non-tablet desiccant products on the market today. People use flaked calcium chloride but such materials lead to spills and messes when loading up a device. There are devices that use a pouch full of flaked calcium chloride. However, the pouch does not completely dissolve, so there is more waste for the consumer to throw away. Also, if the pouch is set in the device incorrectly, the pouch could lean against the interior wall of the device leading to brine leaking outside the device during operation. There are devices that contain donut tablets that are placed on an “arm” within the device but such devices have disadvantages. For example, after the donut tablet reaches midlife the donut tablet falls off the “arm” and can rest on the interior wall of the device leading to brine leaking outside of the package.

Thus, there is a need for a device that overcomes the aforementioned disadvantages.

### SUMMARY OF THE INVENTION

The present invention relates to a spill resistant brine and moisture absorbing device. The spill resistant brine and moisture absorbing device uses a compressed desiccant tablet. More particularly, the device is designed to hold a compressed desiccant tablet, preferably without a central hole.

In an embodiment of the invention, the device contains or is adapted to contain a compressed deliquescent desiccant tablet that comprises calcium chloride, consists essentially of calcium chloride, or consists of calcium chloride.

In an embodiment of the invention, the device features a spill resistant or essentially no-spill design where if the device is knocked over by accident, for example, a drainage port does not allow liquid to fall out of the device. The device of the present invention is advantageously spill resistant or essentially no-spill from when in operation to the collection of brine.

In an embodiment of the invention, there is a pour spout to allow emptying of the device when it is full without fully disassembling the device.

The device comprises an area where a tablet is placed and held in place as the tablet dissolves into a brine collection basin.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a perspective view of the device of the present invention.

FIG. 2 is a top view of the device of FIG. 1.

FIG. 3 is a front view of the device of FIG. 1.

FIG. 4 is a sectional view, Section A-A, of FIG. 3.

FIG. 5 is a side view of the device of FIG. 1.

FIG. 6 is a sectional view, Section C-C, of FIG. 5.

FIG. 7 is a perspective view of the tray of the device of FIG. 1.

FIG. 8 is a top view of the tray of FIG. 7.

FIG. 9 is a sectional view, Section A-A, of FIG. 8.

FIG. 10 is a sectional view, Section C-C, of FIG. 8.

FIG. 11 is a side view of the tray of FIG. 7.

FIG. 12 is a sectional view, Section D-D, of FIG. 11.

FIG. 13A is an end view of the tray of FIG. 7 facing the spout.

FIG. 13B is a bottom view of the tray of FIG. 7.

FIG. 14 is a perspective view of the lid of the device of FIG. 1.

FIG. 15 is a top view of the lid of FIG. 14.

FIG. 16 is a sectional view, Section A-A, of FIG. 15.

FIG. 17 is a sectional view, Section B-B, of FIG. 15.

FIG. 18 is a side view of the lid of FIG. 14.

FIG. 19 is an end view of the lid of FIG. 14.

FIG. 20 is a perspective view of the cover of the device of FIG. 1.

FIG. 21 is a top view of the cover of FIG. 20.

FIG. 22 is a side view of the cover of FIG. 20.

FIG. 23 is an end view of the cover of FIG. 20.

FIG. 24 illustrates Detail C of FIG. 23.

FIG. 25 is a perspective view of the basin of the device of FIG. 1.

FIG. 26 is a bottom view of the basin of FIG. 25.

FIG. 27 is a front view of the basin of FIG. 25.

FIG. 28 is a sectional view, Section A-A, of FIG. 26.

FIG. 29 is an end view of the basin of FIG. 25.

### DESCRIPTION OF THE PREFERRED EMBODIMENTS

The following description of the embodiments of the present invention is merely exemplary in nature and is in no way intended to limit the invention, its application, or uses. The present invention has broad potential application and utility, 1, which is contemplated to be adaptable across a wide range of industries. The following description is provided herein solely by way of example for purposes of providing an enabling disclosure of the invention, but does not limit the scope or substance of the invention.

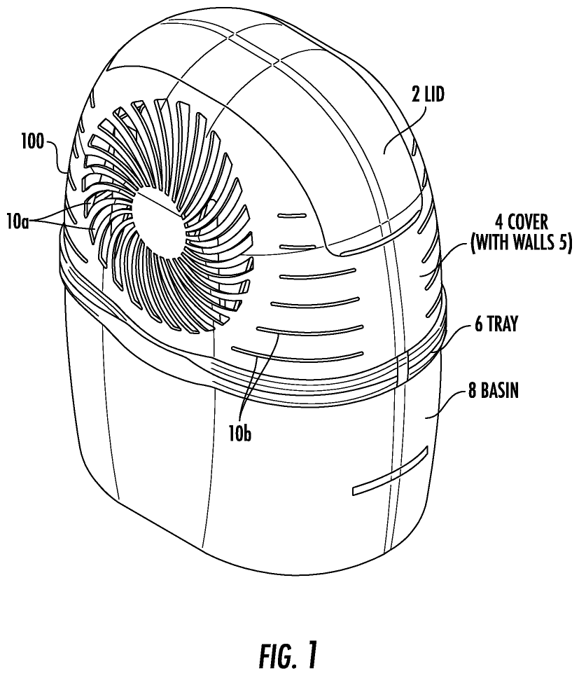

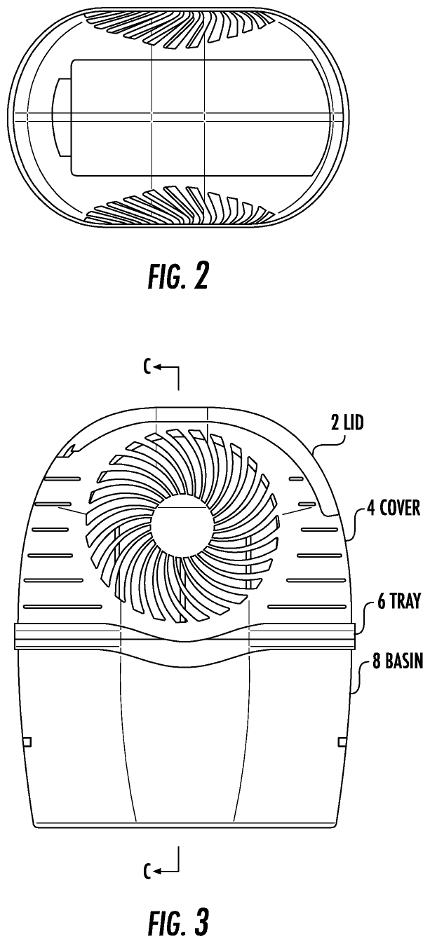

Referring to the figures, FIG. 1 is a perspective view of a moisture absorbing device 100 of the present invention. Device 100 comprises a lid 2 that attachably connects to a cover 4. Cover 4 is comprised of one or more walls 5 having one or more openings 10a and 10b in the walls. Cover 4 is attachably connected from an upper side of a tray 6. A basin 8 having a cavity for collecting brine is attachably connected from an underside of tray 6. FIG. 2 is a top view of the device of FIG. 1.

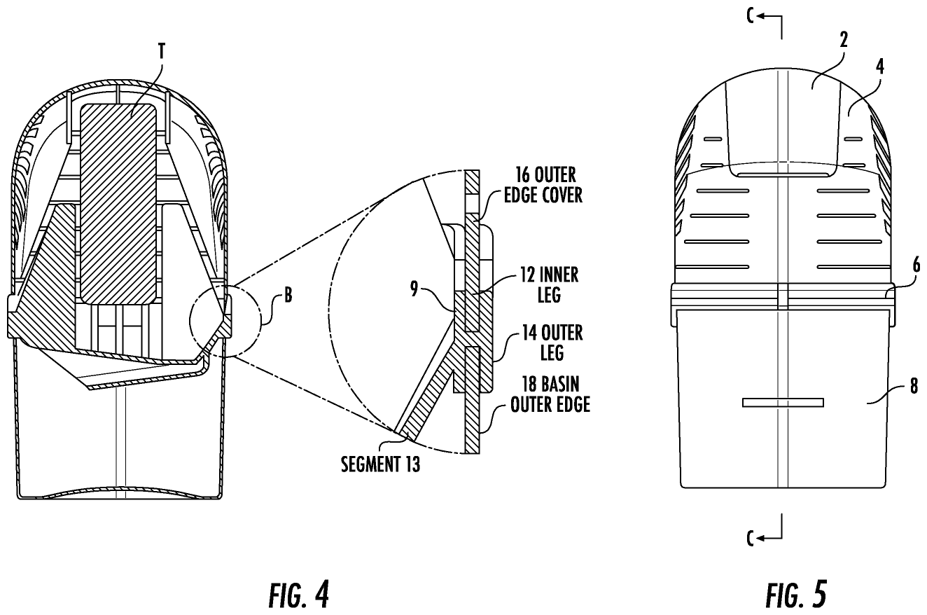

FIG. 3 is a front view of device 100 of FIG. 1. Device 100 having lid 2, cover 4, tray 6, and basin 8. FIG. 4 is a sectional view, Section A-A, of FIG. 3. FIG. 4 illustrates where tablet T is inserted in device 100. Detail B of FIG. 4 illustrates a interlocking edge 9 of tray 6. The interlocking edge is preferably H-shaped and is comprised of an inner leg 12, an outer leg 14, and a center segment 13 connecting inner leg 12 to outer leg 14. The void space formed by the H-shaped interlocking edge engagingly receives an outer cover edge 16 of cover 4 and an outer basin edge 18 of basin 8.

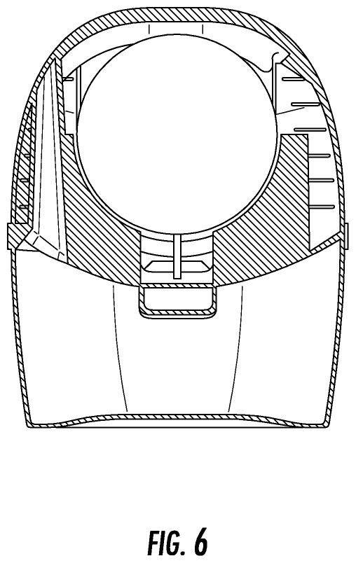

FIG. 5 is a side view of device 100 of FIG. 1. FIG. 6 is a sectional view, Section C-C, of FIG. 5. FIG. 6 illustrates where tablet T is located in device 100.

FIG. 7 is a perspective view of tray 6 of device 100 of FIG. 1. As shown in FIG. 7, tray 6 comprises a tablet holder 20 having a first section 20a having one or more ribs 22a and a second section 20b having one or more ribs 22b. Preferably, the first section and the second section are located a distance apart from one another and are shaped having semicircular edges such that they may receive a circular or semicircular tablet. However, it is within the scope of the present invention that the first section and the second section could be shaped or configured in such a way as to receive a tablet of a non-circular geometrical shape. Tray 6 comprises one or more fins 24 located orthogonally to the tablet holder 20. Preferably, the fins have a vertical edge and a sloping edge. Tray 6 optionally comprises a spout 28 having a cavity 38 for pouring out any brine present in the basin of the device. Spout 28 does not interfere with or touch the tablet. Rim 15 of the tray is shown in FIG. 7. Rim 15 comprises interlocking edge 9 for receiving cover outer edge 16 and basin outer edge 18. Holder 20 and fins 24 advantageously hold a tablet in a manner as to permit substantially the entire sorption surface of the tablet to be in contact with air. Fins 24 restrain the tablet and are preferably relatively narrow so as to contact the tablet along the vertical edges of the fins, thus the vast majority of the outer surface of the tablet is exposed to air.

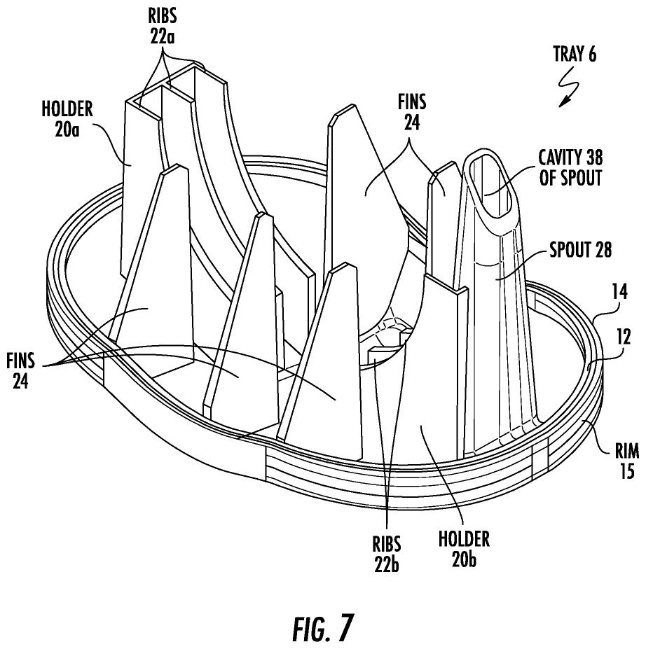

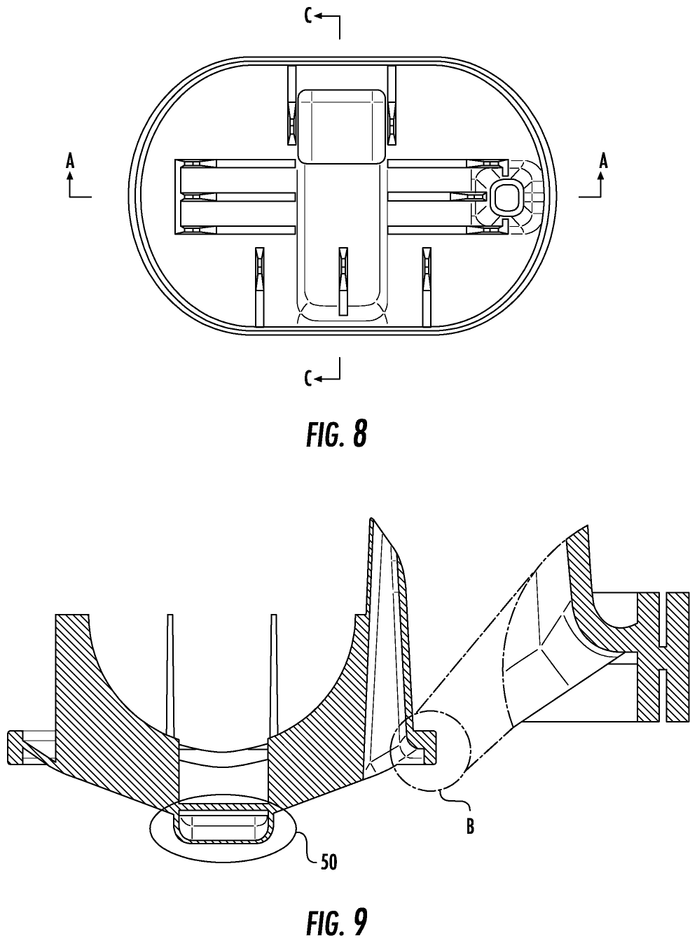

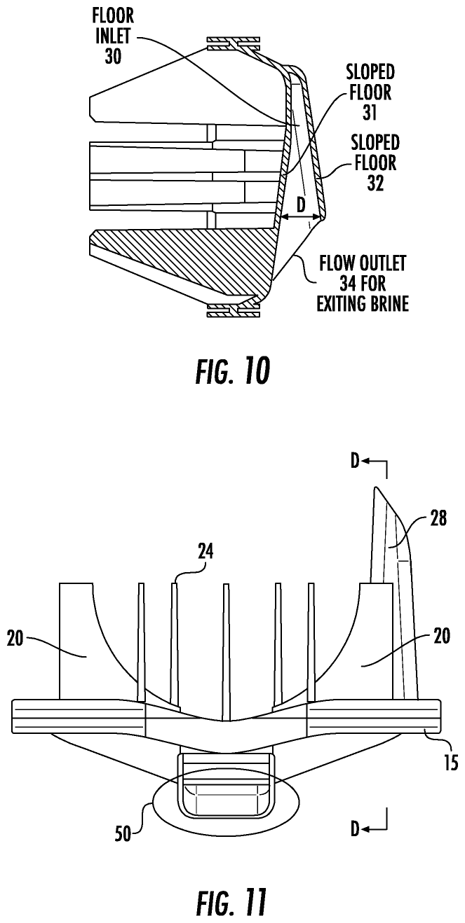

FIG. 8 is a top view of the tray of FIG. 7. FIG. 9 is a sectional view, Section A-A, of FIG. 8. Detail B of FIG. 9 is also shown. Preferably, fins 24 are on opposing sides of the tablet holder. As shown in FIG. 8, three fins are present on one side of the tablet holder and two fins are present on the opposing side of the tablet holder. The center fin between two of the fins is of or notched from the rim. Although shown as offset or notched, one or more of the fins may be flush or offset with the rim. Alternatively, the number arid position of the fins may vary and be positioned differently but still be within the scope of the present invention. A drainage port 50 is shown in FIG. 9. FIG. 10 is a sectional view, Section C-C, of FIG. 8. FIG. 10 illustrates a first sloped partial floor 31 connected to or formed continuously with an outer wall of the tray, and a second sloped partial floor 32 connected to or formed continuously with the H-shaped interlocking edge. There is a flow inlet 30 where sloped floor 31 ends and a flow outlet 34 for exiting brine where sloped floor 32 ends. First sloped partial floor 31 and second sloped partial floor 32 are spaced a varying vertical distance d from one another such that they do not meet. This is advantageous in order to permit brine to flow naturally into the basin of device 100 as the tablet dissolves.

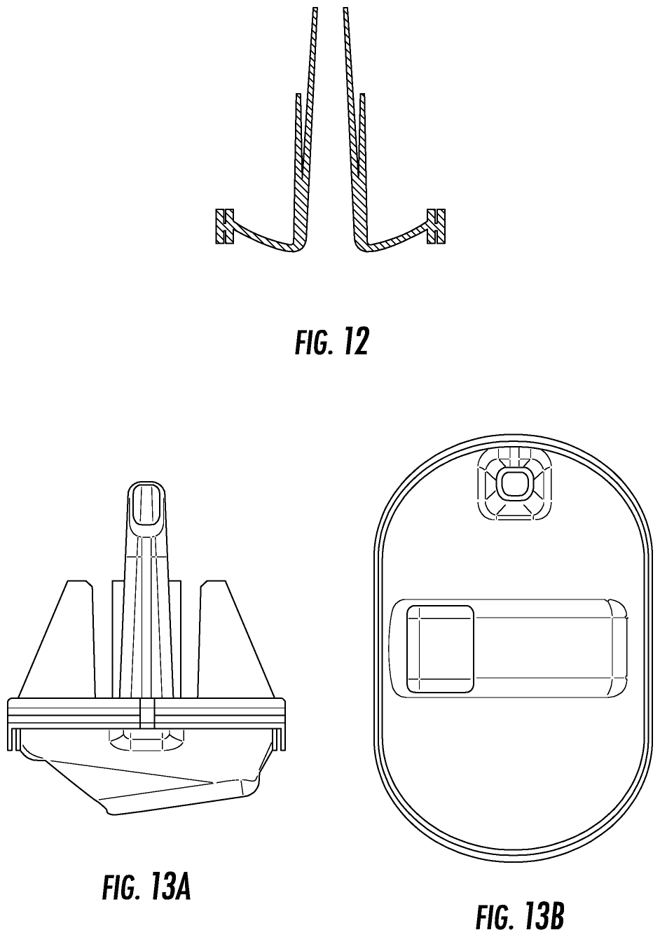

FIG. 11 is a side view of the tray of FIG. 7. FIG. 11 illustrates drainage port 50. FIG. 12 is a sectional view, Section D-D, of FIG. 11. FIG. 13A is an end view of the tray of FIG. 7 facing the spout. FIG. 13B is a bottom view of the tray of FIG. 7.

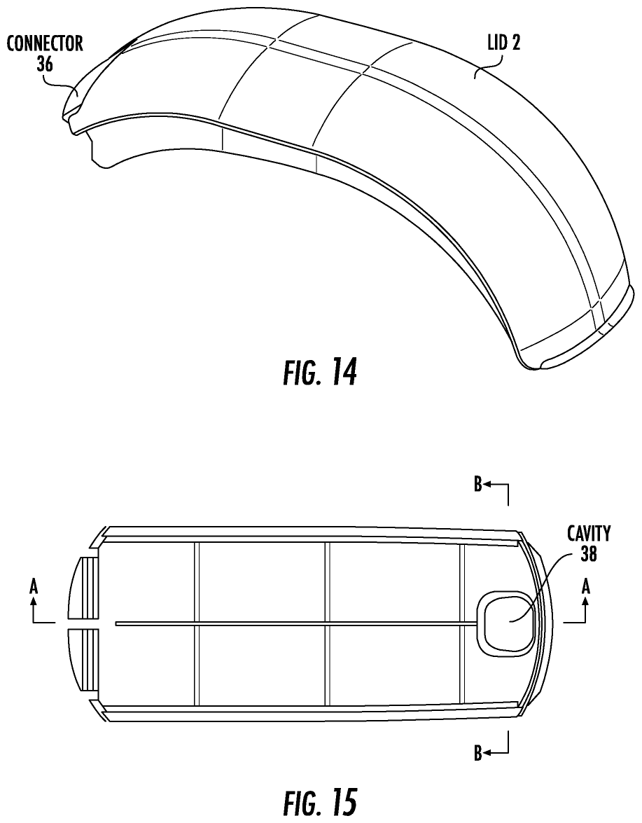

FIG. 14 is a perspective view of lid 2 of device 100 of FIG. 1. Preferably, lid 2 has a curvature to fit the curvature of the cover. Preferably, lid 2 is attached to cover 4 at one of its ends by a connector 36. A connector can be, for example, a hinge, a rod, or a pin. The lid is movable for purposes of inserting a tablet in the device and then providing closure.

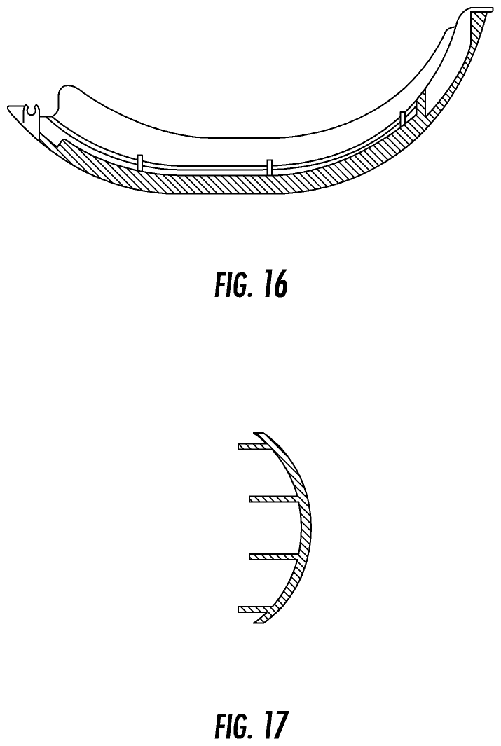

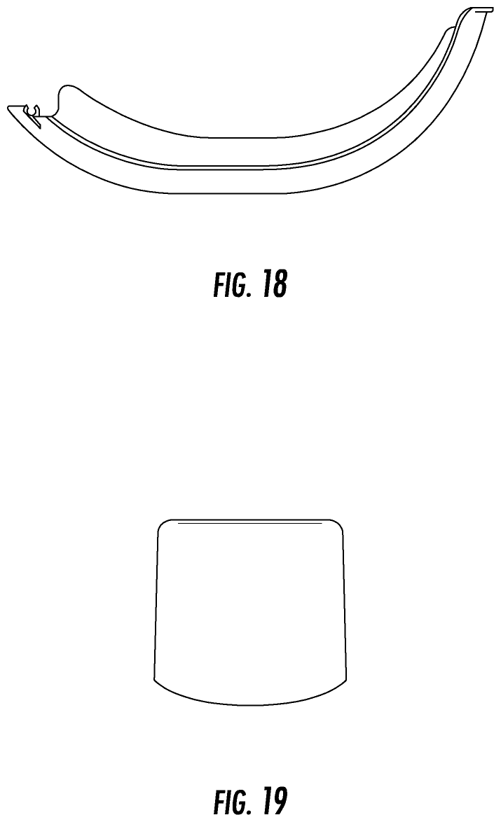

FIG. 15 is a top view of the lid of FIG. 14. A cavity 38 of spout 28 is shown. FIG. 16 is a sectional view, Section A-A, of FIG. 15. FIG. 17 is a sectional view, Section B-B, of FIG. 15.

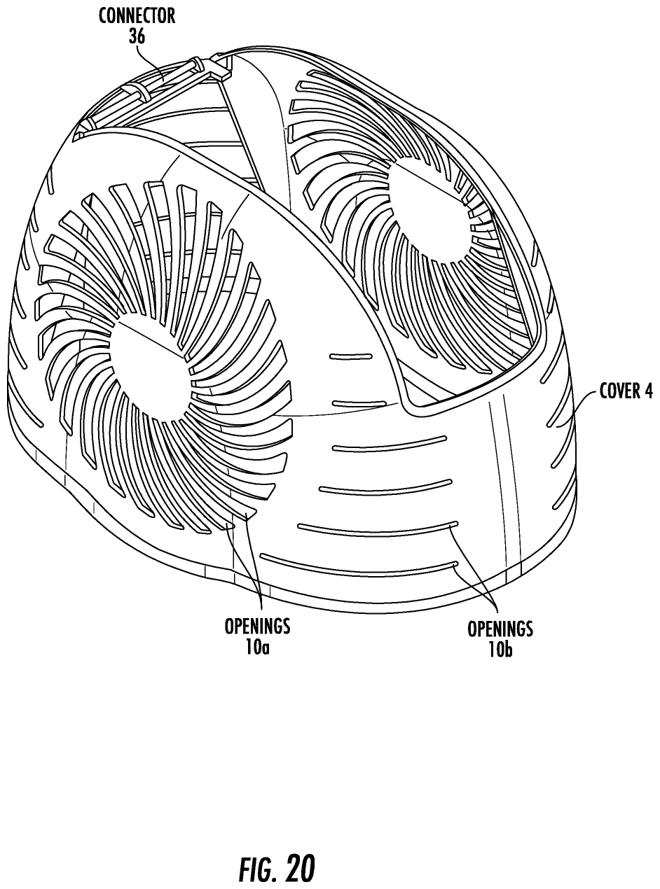

FIG. 18 is a side view of the lid of FIG. 14. FIG. 19 is an end view of the lid of FIG. 14.

FIG. 20 is a perspective view of cover 4 of the device of FIG. 1. FIG. 20 illustrates the one or more openings 10a and 10b in the wall(s) of the cover. Preferably, a plurality of openings as shown. Connector 36 is also illustrated in a form of a hinge.

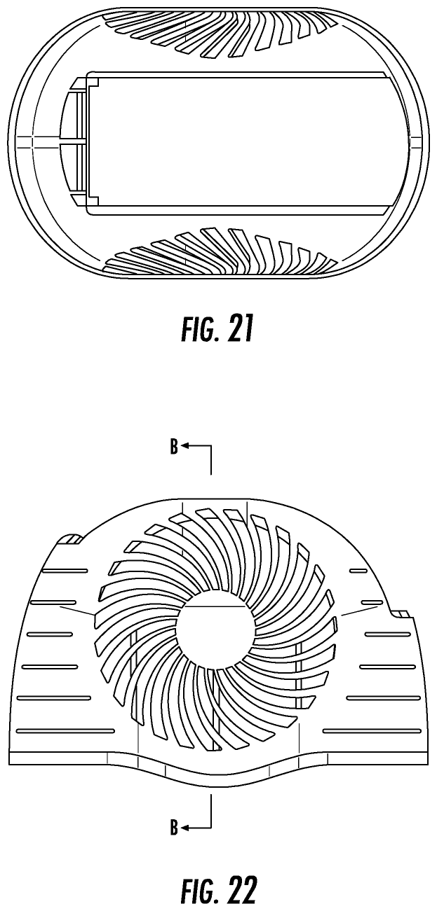

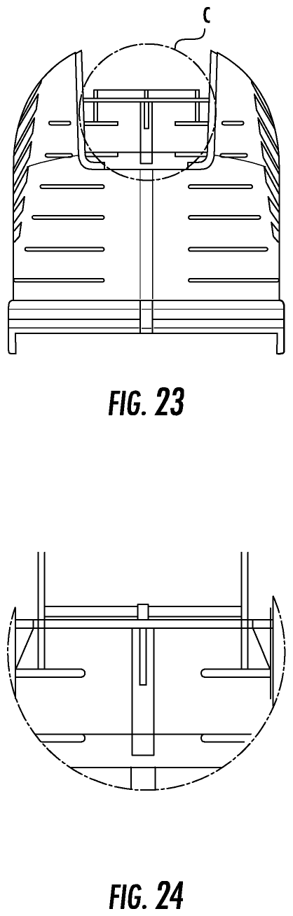

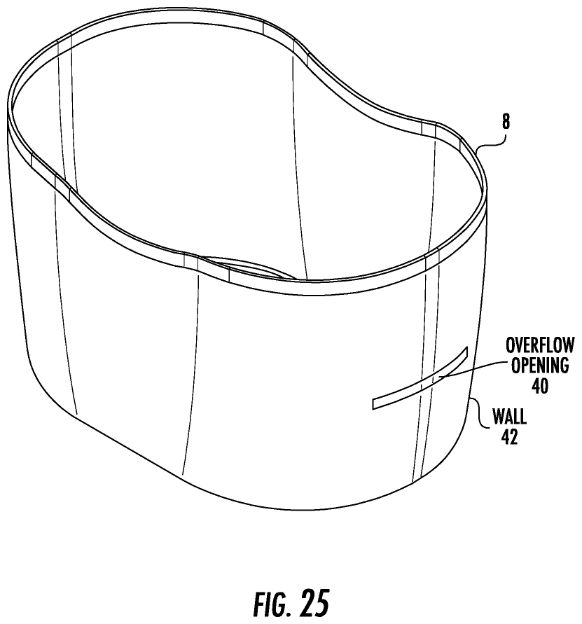

FIG. 21 is atop view of the cover of FIG. 20. FIG. 22 is a side view of the cover of FIG. 20. FIG. 23 is an end view of the cover of FIG. 20. FIG. 24 illustrates Detail C of FIG. 23.

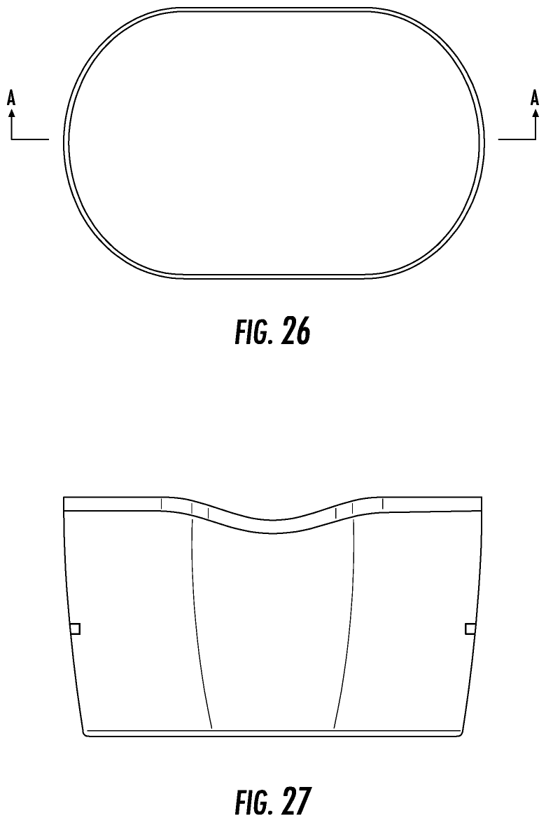

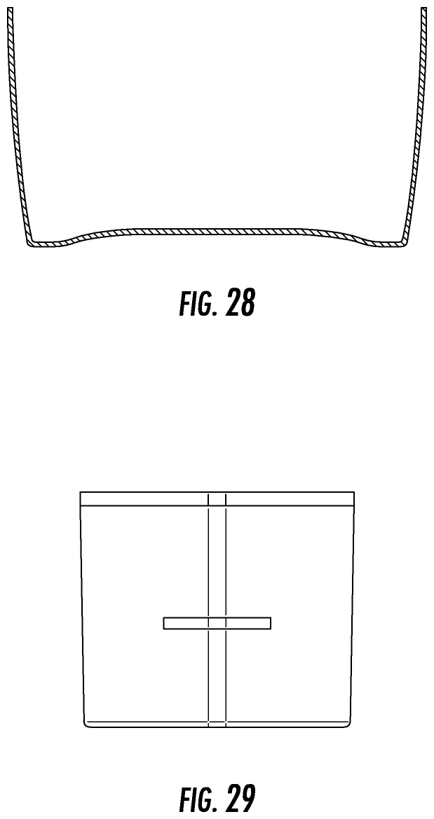

FIG. 25 is a perspective view of basin 8 of device 100 of FIG. 1. FIG. 25 illustrates basin 8 having an overflow opening 40 in a wall 42 of the basin. FIG. 26 is a bottom view of the basin of FIG. 25. FIG. 27 is a front view of the basin of FIG. 25. FIG. 28 is a sectional view, Section A-A, of FIG. 26. FIG. 29 is an end view of the basin of FIG. 25.

Among the advantages of the device of the present invention are the following. The tray, which is preferably located in the middle of the device, permits the tablet to rest in a single location throughout the life of the tablet and maximizes the surface area of the tablet exposed to the environment leading to more effective moisture absorption. The device prevents the tablet from falling over onto the side of the interior wall which can lead to leaking on the outside of the device during operation. The tray has fins that are positioned and cut with a notch from the side wall which prevents leaking when the device is collecting humidity. The device also has a tight fit between the tray and the basin. The bevel of the edge prevents brine from leaking out of the device if the device is knocked over after the device has collected the brine.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A device comprising:
a lid;
a cover having a wall with an opening and attachably connected to the lid;
a tray having an upper side and an underside and attachably connected to the cover from an upper side of the tray; and
a basin having a cavity for collection of brine and attachably connected from the underside of the tray;
wherein the tray comprises a holder for holding a desiccant tablet.

2. The device according to claim 1, wherein the device is spill resistant or essentially no-spill.

3. The device according to claim 1, wherein the tray has a rim with an interlocking edge.

4. The device according to claim 1, wherein the interlocking edge is H-shaped having an inner leg, an outer leg, and a center segment connecting the inner leg to the outer leg.

5. The device according to claim 1, wherein a void space is formed by the H-shaped interlocking edge to engagingly receive an outer cover edge of the cover and an outer basin edge of the basin.

6. The device according to claim 1, wherein the tablet holder comprises a first section and a second section configured to receive a tablet of a geometrical shape.

7. The device according to claim 6, wherein the geometrical shape is circular or semicircular.

8. The device according to claim 1, wherein the tray comprises a fin.

9. The device according to claim 8, wherein the fin is located orthogonal to the tablet holder.

10. The device according to claim 8, wherein the fin has a vertical edge and a sloping edge.

11. The device according to claim 8, wherein the fms are present in a set.

12. The device according to claim 11, wherein a first set of fins is present on one side of the tablet holder and a second set of two fins is present on the opposing side of the tablet holder.

13. The device according to claim 8, wherein a fin is flush with the rim of the tray.

14. The device according to claim 8, wherein a fin is offset with the rim of the tray.

15. The device according to claim 1, wherein the tray further comprises a spout having a cavity.

16. The device according to claim 1, wherein the tray further comprises a first sloped partial floor and a second sloped partial floor.

17. The device according to claim 16, wherein the first sloped partial floor is connected to or formed continuously with an outer wall of the tray.

18. The device according to claim 16, wherein the second sloped partial floor is connected to or formed continuously with the interlocking edge of the tray.

19. The device according to claim 16, wherein the first sloped partial floor and second sloped partial floor are spaced apart by a vertical distance.

20. The device according, to claim 1, wherein the device further comprises a drainage port.

21. A tray comprising:
a tablet holder having a first section having one or more ribs and a second section having one or more ribs,
wherein the first section and the second section are located a distance apart from one another and are shaped having semicircular edges for the ribs of the first section and of the second section to receive a circular or semicircular tablet, and
a fin located orthogonal to the tablet holder.

22. The tray according to claim 21, wherein the tray has a rim with an interlocking edge.

23. The tray according to claim 22, wherein the interlocking edge is H-shaped.

24. The tray according to claim 23, wherein a void space is formed by the H-shaped interlocking edge to engagingly receive an outer cover edge of the cover and an outer basin edge of the basin.

25. The tray according to claim 21, wherein the fin has a vertical edge and a sloping edge.

26. The tray according to claim 21, wherein the fin is flush with the rim of the tray.

27. The tray according to claim 21, wherein a fin is offset with the rim of the tray.

28. The tray according to claim 21, wherein the tray further comprises a spout having a cavity.

29. The tray according to claim 21, wherein the tray further comprises a first sloped partial floor and a second sloped partial floor.

30. The tray according to claim 29, wherein the first sloped partial floor is connected to or formed continuously with an outer wall of the tray.

31. The tray according to claim 29, wherein the second sloped partial floor is connected to or formed continuously with an interlocking edge of the tray.

32. The tray according to claim 29, wherein the first sloped partial floor and second sloped partial floor are spaced apart by a vertical distance.
